(19) United States
(12) Patent Application Publication
(10) Pub. No.: US 2012/0330584 A1
(43) Pub. Date: Dec. 27, 2012

(54) Systems and Methods for Power Monitoring in a Variable Data Processing System

(75) Inventors: Changyou Xu, Fremont, CA (US); Shaohua Yang, Santa Clara, CA (US); Zongwang Li, San Jose, CA (US); Yang Han, Sunnyvale, CA (US)

(73) Assignee: LSI Corporation

(21) Appl. No.: 13/167,760

(22) Filed: Jun. 24, 2011

(51) Int. Cl. G06F 19/00

(52) U.S. Cl. 702/61

(57) ABSTRACT

Various embodiments of the present invention provide systems and methods for data processing. As an example, a data processing circuit is discussed that includes: a data detector circuit, a data decoder circuit, and a power monitor circuit. The data detector circuit is operable to apply a data detection algorithm to a data input and a decoded output to yield a detected output. The data decoder circuit is operable to apply a data decoding algorithm to the detected output to yield the decoded output. The power monitor circuit is operable to receive a first power status signal from the data detector circuit and a second power status from the data decoder circuit, and to calculate a power usage of a combination of at least the data detector circuit and the data decoder circuit. In such a system, a number of global iterations through a combination of the data decoder circuit and the data detector circuit is variable and both of the first power status signal and the second power status signal varies at least in part as a function of the number of global iterations.

### BACKGROUND OF THE INVENTION

The present inventions are related to systems and methods for data processing, and more particularly to systems and methods for power monitoring a data processing system.

Various data transfer systems have been developed including storage systems, cellular telephone systems, radio transmission systems. In each of the systems data is transferred from a sender to a receiver via some medium. For example, in a storage system, data is sent from a sender (i.e., a write function) to a receiver (i.e., a read function) via a storage medium. In some cases, the data processing function uses a variable number of iterations depending upon the characteristics of the data being processed. The variable number of processing iterations result in ambiguity in determining circuit power requirements, and can require the choice of an expensive packaging designed to dissipate power at a higher rate than may actually be required.

Hence, for at least the aforementioned reasons, there exists a need in the art for advanced systems and methods for data processing.

### BRIEF SUMMARY OF THE INVENTION

The present inventions are related to systems and methods for data processing, and more particularly to systems and methods for power monitoring a data processing system.

Various embodiments of the present invention provide data processing circuits that include: a data detector circuit, a data decoder circuit, and a power monitor circuit. The data detector circuit is operable to apply a data detection algorithm to a data input and a decoded output to yield a detected output. The data decoder circuit is operable to apply a data decoding algorithm to the detected output to yield the decoded output. The power monitor circuit is operable to receive a first power status signal from the data detector circuit and a second power status from the data decoder circuit, and to calculate a power usage of a combination of at least the data detector circuit and the data decoder circuit. In such a system, a number of global iterations through a combination of the data decoder circuit and the data detector circuit is variable and both of the first power status signal and the second power status signal varies at least in part as a function of the number of global iterations. In some instances of the aforementioned embodiments, a number of local iterations through the data decoder circuit is variable and the second power status signal varies at least in part as a function of the number of local iterations. In various cases, the data detector circuit is a Viterbi algorithm detector circuit. In other cases, the data detector circuit is a maximum a posteriori algorithm detector circuit. In some cases, the data decoder circuit is a low density parity check decoder circuit. Based upon the disclosure provided herein, one of ordinary skill in the art will recognize a variety of data decoder circuits and data detector circuits that may be used in relation to different embodiments of the present invention.

In some instances of the aforementioned embodiments, the first power status signal indicates the data detector circuit is busy when asserted and indicates the data detector circuit is idle when de-asserted; and the second power status signal indicates the data decoder circuit is busy when asserted and indicates the data decoder circuit is idle when de-asserted. In various cases of the aforementioned embodiments, the circuit further includes: a comparator circuit and a disabling output. The comparator circuit is operable to compare the power usage with a threshold to yield a comparison output. The disabling output is operable to disable at least the data decoder circuit when the comparison output indicates that the power usage is greater than the threshold. In some cases, the circuit includes a threshold calculation circuit operable to calculate the threshold based at least in part on a desired utilization and a window size. In some cases, the desired utilization and the window size are programmable.

In some cases, the circuit is implemented as part of an integrated circuit. In various cases, the circuit is incorporated in a storage device. In other cases, the circuit is incorporated in a data transmission device. Based upon the disclosure provided herein, one of ordinary skill in the art will recognize a variety of devices into which the circuits may be incorporated.

In some instances of the aforementioned embodiments, the power monitor circuit includes a first mode circuit and a second mode circuit. The first mode circuit uses a feedback based approach to calculate the power usage. The second mode circuit is operable to accumulate a power status over a window of time, and to provide the accumulated power status as the power usage. In various instances of the aforementioned embodiments, the circuit further includes a power status normalization circuit operable to normalize the first power status signal and the second power status signal to one, and to aggregate the normalized first power status signal and the normalized second power status signal to yield the power usage.

Other embodiments of the present invention provide data processing circuits that include a data detector circuit, a data decoder circuit, a first power monitor circuit, a second power monitor circuit, and an aggregator circuit. The data detector circuit is operable to apply a data detection algorithm to a data input and a decoded output to yield a detected output. The data decoder circuit is operable to apply a data decoding algorithm to the detected output to yield the decoded output. The first power monitor circuit is operable to receive a first power status signal from the data detector circuit and to calculate a first power usage of the data detector circuit, and the second power monitor circuit is operable to receive a second power status signal from the data decoder circuit and to calculate a second power usage of the data decoder circuit. A number of local iterations through the data detector circuit is variable and the first power status signal varies at least in part as a function of the number of local iterations through the data detector circuit. A number of local iterations through the data decoder circuit is variable and the first power status signal varies at least in part as a function of the number of local iterations through the data detector circuit. A number of global iterations through a combination of the data decoder circuit and the data detector circuit is variable and both of the first power status signal and the second power status signal varies at least in part as a function of the number of global iterations. The aggregator circuit is operable to combine the first power usage with the second power usage to yield a composite power usage.

In some instances of the aforementioned embodiments, the first power status signal indicates the data detector circuit is busy when asserted and indicates the data detector circuit is idle when de-asserted; and the second power status signal indicates the data decoder circuit is busy when asserted and indicates the data decoder circuit is idle when de-asserted. In various cases, the aforementioned circuits further include: a comparator circuit and a disabling output. The comparator circuit is operable to compare the composite power usage with a threshold to yield a comparison output. The disabling output is operable to disable at least the data decoder circuit when the comparison output indicates that the power usage is greater than the threshold.

Yet other embodiments of the present invention provide power monitoring circuits that include: a threshold calculation circuit, a utilization circuit, a first mode circuit, a second mode circuit, and a comparator circuit. The threshold calculation circuit is operable to calculate a threshold based at least in part on a desired utilization and a window size. The utilization circuit is operable to calculate a utilization value based upon an assertion level of a first power status signal from a data detector circuit and an assertion level of a second power status signal from a data decoder circuit. The first mode circuit is operable to use a feedback based approach to calculate a power usage based at least in part on the utilization value, and the second mode circuit is operable to accumulate a power status over a window of time, and to provide the accumulated power status as the power usage. The comparator circuit is operable to compare the power usage with the threshold to yield a comparison output.

This summary provides only a general outline of some embodiments of the invention. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 shows a storage system including a power monitoring circuit in accordance with various embodiments of the present invention;

FIG. 2 depicts a data transmission system including a power monitoring circuit in accordance with one or more embodiments of the present invention;

FIG. 3a shows a power monitor circuit in accordance with some embodiments of the present invention;

FIG. 3b depicts a power status normalization circuit that may be used in relation to the power monitor circuit of FIG. 3a;

FIG. 4 depicts a combination variable data processing circuit and power monitor circuit in accordance with various embodiments of the present invention;

FIG. 5 is a flow diagram showing a method in accordance with some embodiments of the present invention for power monitoring in a variable data processing system; and

FIG. 6 is a flow diagram showing a method in accordance with one or more embodiments of the present invention for governing a variable data processing circuit based on power monitoring thresholds.

### DETAILED DESCRIPTION OF THE INVENTION

The present inventions are related to systems and methods for data processing, and more particularly to systems and methods for power monitoring a data processing system.

Various embodiments of the present invention provide for power monitoring in a variable data processing system. As an example, a variable data processing system may include a data detector circuit and a data decoder circuit through which data is passed in an attempt to recover the original data. Depending upon characteristics of the received data, the data may pass a variable number of times through both the data detector circuit and the data decoder circuit (i.e., a global iteration), may pass a variable number of times through the data detector circuit before being passed on to the data decoder circuit (i.e., a local detector iteration), and/or may pass a variable number of times through the data decoder circuit before being passed back to either the data detector circuit or on as a hard output (i.e., a local decoder iteration). A power monitor circuit receives status signals (e.g., busy/idle) from both the data detector circuit and the data decoder circuit, and based thereon generates estimates of both average and instant power utilization. In some cases, this power information may be used to govern operation of the data processing circuit. For example, where the average power exceeds a given limit, operation of the data decoder circuit may be periodically stopped to reduce the possibility of package overheating.

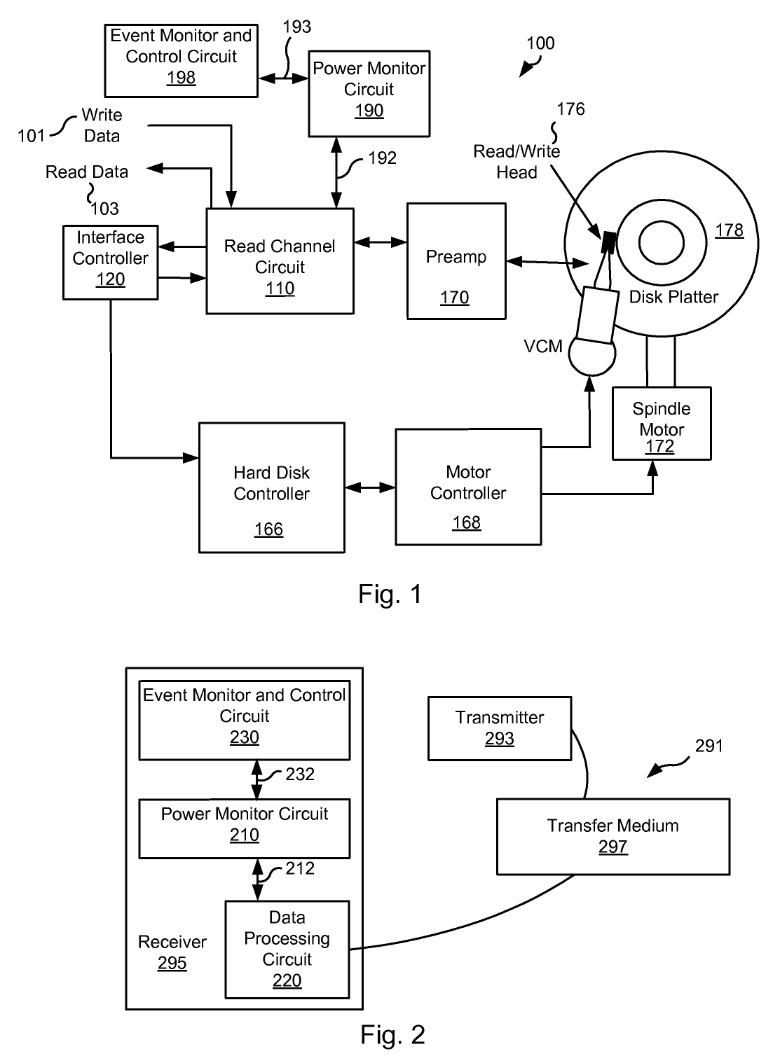

Turning to FIG. 1, a storage system 100 including a read channel circuit 110 communicating with a power monitor circuit 190 is shown in accordance with various embodiments of the present invention. Storage system 100 may be, for example, a hard disk drive. Storage system 100 also includes a preamplifier 170, an interface controller 120, a hard disk controller 166, a motor controller 168, a spindle motor 172, a disk platter 178, a read/write head 476, and an event monitor and control circuit 198. Interface controller 120 controls addressing and timing of data to/from disk platter 178. The data on disk platter 178 consists of groups of magnetic signals that may be detected by read/write head assembly 176 when the assembly is properly positioned over disk platter 178. In one embodiment, disk platter 178 includes magnetic signals recorded in accordance with either a longitudinal or a perpendicular recording scheme.

In a typical read operation, read/write head assembly 176 is accurately positioned by motor controller 168 over a desired data track on disk platter 178. Motor controller 168 both positions read/write head assembly 176 in relation to disk platter 178 and drives spindle motor 172 by moving read/write head assembly to the proper data track on disk platter 178 under the direction of hard disk controller 166. Spindle motor 172 spins disk platter 178 at a determined spin rate (RPMs). Once read/write head assembly 176 is positioned adjacent the proper data track, magnetic signals representing data on disk platter 178 are sensed by read/write head assembly 176 as disk platter 178 is rotated by spindle motor 172. The sensed magnetic signals are provided as a continuous, minute analog signal representative of the magnetic data on disk platter 178. This minute analog signal is transferred from read/write head assembly 176 to read channel circuit 110 via preamplifier 170. Preamplifier 170 is operable to amplify the minute analog signals accessed from disk platter 178. In turn, read channel circuit 110 decodes and digitizes the received analog signal to recreate the information originally written to disk platter 178. This data is provided as read data 103 to a receiving circuit. A write operation is substantially the opposite of the preceding read operation with write data 101 being provided to read channel circuit 110. This data is then encoded and written to disk platter 178.

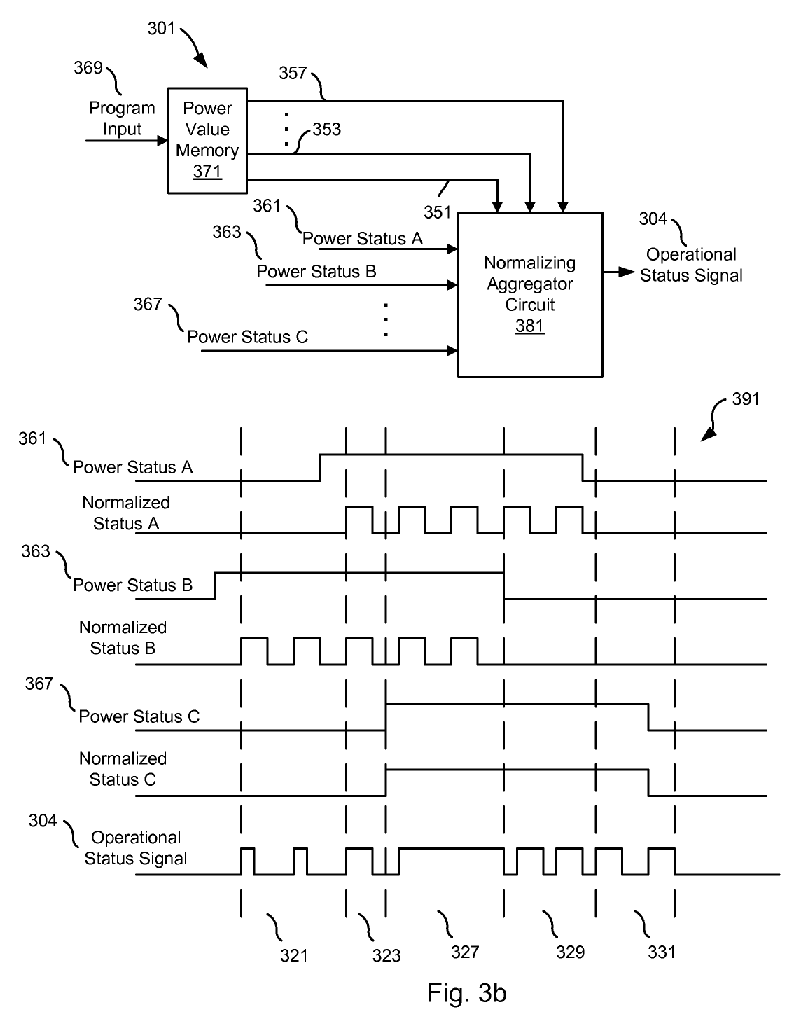

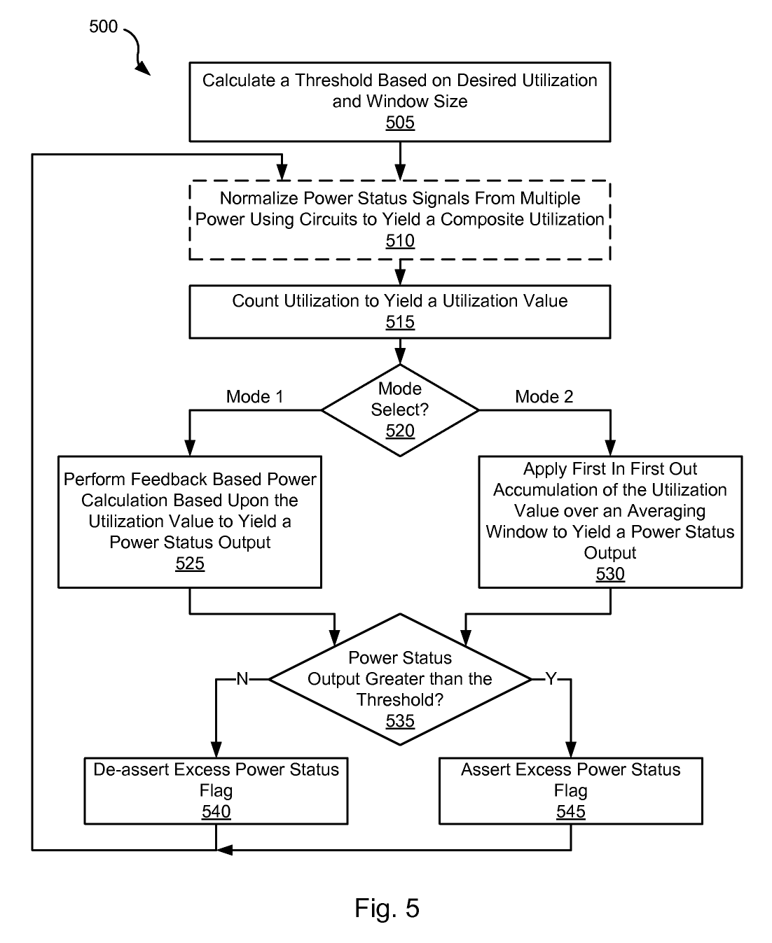

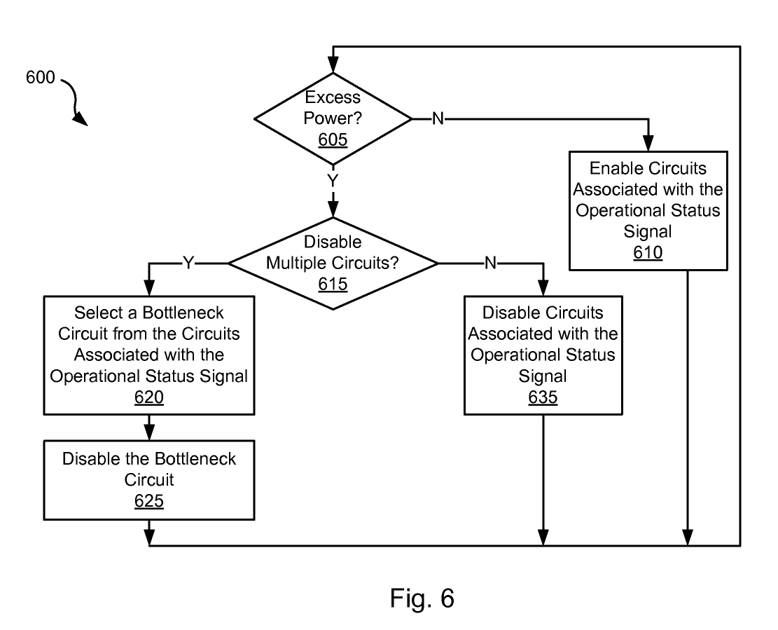

As part of processing the received information, read channel circuit 110 utilizes a variable data processing circuit that allows different chunks of data to utilize different amounts of processing bandwidth depending, for example, upon the signal to noise ratio exhibited by a received data set. The processing bandwidth is distributed between data detector circuits, data decoder circuits, and the associated memories. Status signals 192 (e.g., idle/busy, enable) are provided between power monitor circuit 190 and read channel circuit 110. Power monitor circuit 190 calculates an estimated average and/or instant power usage and provides this information via status signals 193 to an event monitor and control circuit 198. Where the power usage exceeds a defined limit, one of status signals 193 may be asserted causing power monitor circuit 190 to assert an enable signal (one of status signals 192) to disable or otherwise regulate one or more processors in reach channel circuit 110. Power monitor circuit 190 may be implemented similar to that discussed in relation to FIG. 3 below, and/or power monitor circuit 190 and event monitor and control circuit 198 may operate similar to that discussed below in relation to FIGS. 5 and 6.

It should be noted that storage system 100 may be integrated into a larger storage system such as, for example, a RAID (redundant array of inexpensive disks or redundant array of independent disks) based storage system. It should also be noted that various functions or blocks of storage system 100 may be implemented in either software or firmware, while other functions or blocks are implemented in hardware.

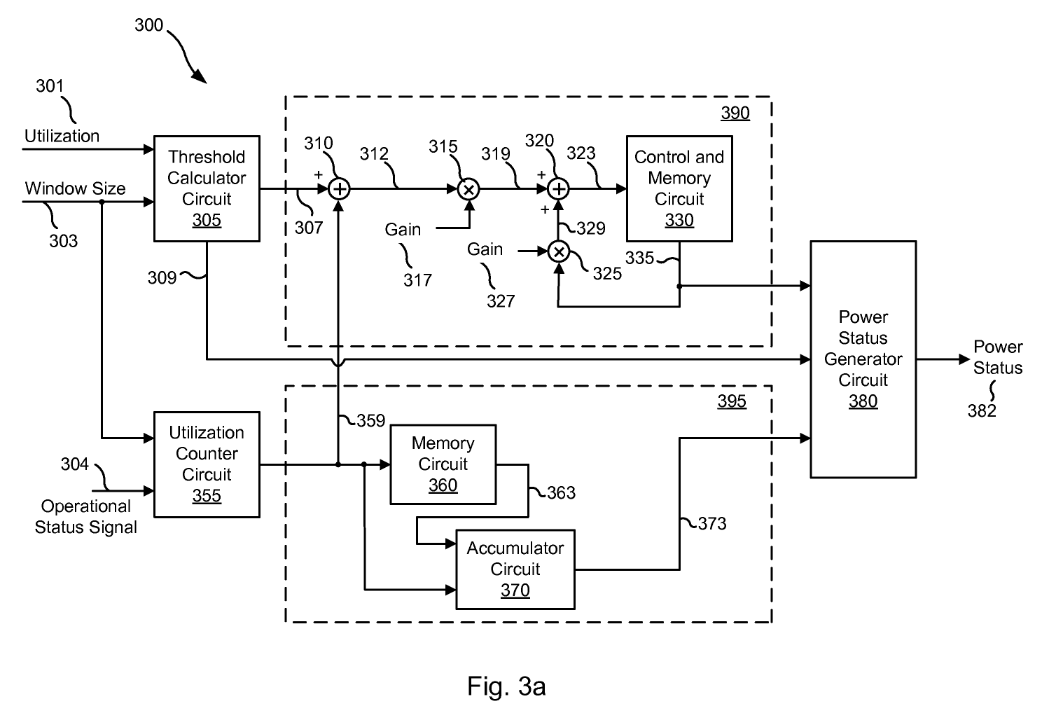

Turning to FIG. 2, a data transmission system 200 including a power monitoring circuit 210 is shown in accordance with one or more embodiments of the present invention. Data transmission system 200 includes a transmitter 293 that is operable to transmit encoded information via a transfer medium 297 as is known in the art. The encoded data is received from transfer medium 297 by a receiver 295. Receiver 295 includes a data processing circuit 220, power monitor circuit 210, and event monitor and control circuit 230. Data processing circuit 220 is a variable data processing circuit that allows different chunks of data to utilize different amounts of processing bandwidth depending, for example, upon the signal to noise ratio exhibited by a received data set. The processing bandwidth is distributed between data detector circuits, data decoder circuits, and the associated memories. Status signals 212 (e.g., idle/busy, enable) are provided between power monitor circuit 210 and data processing circuit 220. Power monitor circuit 210 calculates an estimated average and/or instant power usage and provides this information via status signals 232 to event monitor and control circuit 230. Where the power usage exceeds a defined limit, one of status signals 232 may be asserted causing power monitor circuit 210 to assert an enable signal (one of status signals 212) to disable or otherwise regulate one or more processors in data processing circuit 220. Power monitor circuit 210 may be implemented similar to that discussed in relation to FIG. 3 below, and/or power monitor circuit 210 and event monitor and control circuit 230 may operate similar to that discussed below in relation to FIGS. 5 and 6.

Turing to FIG. 3a, a power monitor circuit 300 is shown in accordance with some embodiments of the present invention. Power monitor circuit 300 includes a mode one check circuit 390 and a mode two check circuit 395. In addition, power monitor circuit 300 includes a threshold calculator circuit 305, a utilization counter circuit 355, and a power status generator circuit 380. Threshold calculator circuit 305 receives a utilization input 301 that is a programmed input indicating a maximum power utilization. In some cases, utilization input 301 is a value between 0 and 100. In addition, threshold calculator circuit 305 receives a window size input 303 that is programmed to indicate a time (e.g., a number of bit periods) over which the power measurements are to be averaged. In some cases, window size input 303 is fixed at 1024. Threshold calculator circuit 305 calculates threshold outputs 309, 307 in accordance with the following equation:

Threshold 309=Threshold 307=(Utilization Input 301)*(Window Size Input 305)/100.

Utilization counter circuit 355 receives window size input 303 and an operational status signal 304. Operational status signal 304 has a duty cycle that corresponds to a busy/idle state of a power using circuit (not shown). Where, for example, the power using circuit is always busy, the duty cycle is 100% (i.e., always asserted). Alternatively, where the power using circuit is busy half of the time, the duty cycle is 50% (i.e., asserted half of the time). In some cases, operational status signal 304 may be a composite of multiple power status signals as more fully described below in relation to FIG. 3b. Utilization counter circuit 305 counts the number of asserted periods over the window size to yield a utilization value 359. For example, where window size input 303 is 1024, utilization counter circuit 305 counts the number of asserted periods of operational status signal 304 over the most recent 1024 bit periods. As a particular example, where the duty cycle of operational status signal 304 is a constant 50% over the window, utilization value 359 is 512 (i.e., ½ of 1024).

Mode one check circuit 390 uses a feedback based approach to calculate approximate power usage. In particular, first mode circuit 390 includes a summation circuit 310 that adds utilization value 359 and threshold 307 to yield a sum output 312 in accordance with the following equation:

Sum output 312=utilization value 359+threshold 307.

Sum output 312 is then multiplied by a gain factor 317 using a multiplier circuit 315 to yield a scaled output 319 in accordance with the following equation:

Scaled output 319=(sum output 312)*(gain 317).

Scaled output 319 is added to a scaled output 329 to yield a sum output 323 in accordance with the following equation:

Sum output 323=Scaled output 319+Scaled output 329.

Sum output 323 is provided to a control and memory circuit 330 where the calculated value is stored and provided as a power status output 335 to a power status generator circuit 380. In addition, power status output 335 is multiplied by a gain factor 327 using a multiplier circuit 325 to yield scaled output 329 in accordance with the following equation:

Scaled output 329=(power status output 335)*(gain 327).

Overall power status output (P[i+1]) may be calculated in accordance with the following equation:

P[i+1]=P[i]*gain A+(C−W*U/100)*gain b,

where gain a is gain 327, gain b is gain 317, C is utilization value 359, U is utilization input 301, and W is window size input 303.

Mode two check circuit 395 accumulates the utilization over a defined period. In particular, mode two check circuit 395 includes a memory circuit 360 that stores a number of instances of utilization value 359 in a first in/first out fashion. Both the most recent utilization value 359 and the utilization values 363 from memory circuit 360 are provided to an accumulator circuit 370 that sums the values to yield a power status output 373. Power status output 373 is provided to a power status generator circuit 380.

In addition to receiving power status output 373 and power status output 335, power status generator circuit 380 receives threshold 307. When a first mode is selected, power status generator circuit 380 compares power status output 335 against threshold 307. Where threshold 307 is exceeded, power status generator circuit 380 asserts a power status output 382 indicating that too much power is being consumed. Alternatively, when a second mode is selected, power status generator circuit 380 compares power status output 373 against threshold 307. Where threshold 307 is exceeded, power status generator circuit 380 asserts power status output 382 indicating that too much power is being consumed. The following pseudocode describes the operation of power status generator circuit 380:

```
If (First Mode) {
        If (power status output 335 > threshold 307) {
            assert power status output 382
        }
        Else {
            de-assert power status output 382
        }
}
Else {
        If (power status output 373 > threshold 307) {
            assert power status output 382
        }
        Else {
            de-assert power status output 382
        }
}
```

In some cases, where too much power is being consumed, one or more circuits associated with operational status signal 304 are disabled. It should be noted that a power monitor circuit may be implemented that includes only one or the other of first mode circuit 390 and second mode circuit 395.

Turning to FIG. 3b, a power status normalization circuit 301 is shown that may be used in relation to power monitor circuit 300. Power status normalization circuit 301 includes a power value memory 317 that may be programmed using a program input 369. The programming may be performed using any programming interface known in the art. Power value memory 317 is programmed with relative power values corresponding to a number of power status inputs (e.g., power status A 361, power status B 363, power status C 365) that are derived from respective power using circuits (not shown). For example, where power status A 361 is asserted, it may indicate a power usage that is twice what is indicated when either power status B 363 or power status C 365 indicates. Said another way, power status A 361 may indicate when a first circuit is busy, power status B 363 may indicate when a second circuit is busy, and power status A 365 may indicate when a third circuit is busy; and when busy the first circuit utilizes twice the power of the second circuit or the third circuit. This relative power consumption between the power using circuits associated with the respective power status inputs is programmed into power value memory 371, and provided respectively as a gain value 351 corresponding to power status A 361, a gain value 353 corresponding to power status B 363, and a gain value 357 corresponding to power status C 367.

Powers status A 361 is provided from a power using circuit (not shown) and indicates whether the associated circuit is busy or idle, powers status B 363 is provided from a power using circuit (not shown) and indicates whether the associated circuit is busy or idle, and powers status C 367 is provided from a power using circuit (not shown) and indicates whether the associated circuit is busy or idle. Powers status A 361, power status B 363, power status C 367, gain value 351, gain value 353 and gain value 357 are provided to a normalizing aggregator circuit 381. Normalizing aggregator circuit 381 is operable to normalize each of the received power status signals in accordance with the programmed gain, and to provide operational status signal 304 that represents the normalized combination of the received status signals.

A graph 391 illustrates an example of generating operational status signal 304 based upon three power status signals (i.e., power status signal A 361, power status signal B 363, and power status signal 367) normalized to each other. In this example, the power using circuit associated with power status signal C 367 uses twice the power of the circuit associated with power status B 363 or the power of the circuit associated with power status B 361. This relative power usage is programmed into power value memory 371, and is provided as gain value 351, gain value 353 and gain value 357. When power status A 361 is asserted indicating the corresponding circuit is busy, a normalized status A is asserted half of the time. Similarly, when power status B 363 is asserted indicating the corresponding circuit is busy, a normalized status B is asserted half of the time. In contrast, when power status C 367 is asserted indicating the corresponding circuit is busy, a normalized status C is asserted full time.

The normalized signals (i.e., normalized status A, normalized status B, and normalized status C) are combined into operational status signal 304. The example in graph 391 includes five distinct regions: a region 321 when only the circuit associated with power status B 363 is busy; a region 323 when both the circuit associated with power status B 363 and the circuit associated with power status A 361 are busy; a region 327 when all of the circuit associated with power status B 363, the circuit associated with power status A 361, and the circuit associated with power status C 367 are busy; a region 329 when both the circuit associated with power status C 367 and the circuit associated with power status A 361 are busy; and a region 331 when only the circuit associated with power status C 367 is busy. During each of these regions, the combined output, operational status signal 304, exhibits a different duty cycle. In particular, during region 321 where only the circuit associated with power status B 363 is busy (i.e., a circuit using the same power as the circuit associated with power status A 361, and half the power of the circuit associated with power status C 367), operational status signal 304 is asserted with a one quarter duty cycle. During region 323 where both the circuit associated with power status B 363 and the circuit associated with power status A 361 are busy (i.e., two circuits each using half the power used by the circuit associated with power status C 367 is busy), operational status signal 304 is asserted with a one half duty cycle. During region 327 where all of the circuit associated with power status B 363, the circuit associated with power status A 361, and the circuit associated with power status C 367 are busy, operational status signal 304 is asserted with a full duty cycle. During region 329 where both the circuit associated with power status A 361 and the circuit associated with power status C 367 are busy (i.e., two circuits using a total of three quarters of the combined power), operational status signal 304 is asserted with three quarters duty cycle. Finally, during region 321 where only the circuit associated with power status C 367 is busy (i.e., a circuit using the twice the power as the circuit associated with either power status A 361 or power status B 363), operational status signal 304 is asserted with a one half duty cycle. Operational status signal 304 is provided as an input to power monitor circuit 300.

Of note, power monitor circuit 300 may be used with an input normalization circuit such as power status normalization circuit 301 allowing for monitoring of multiple disparate operational status inputs. Alternatively, a number of power monitor circuits 300 may be used with each of the power monitor circuits 300 assigned to respective operation status signals from the corresponding power using circuit. In such a case, an output aggregation circuit (not shown) may be used to aggregate the multiple power status signals 382, and thus yield an aggregate power status signal. As yet another alternative, a single power monitor circuit 300 may be used to receive a single operational status signal 304 from one power using circuit.

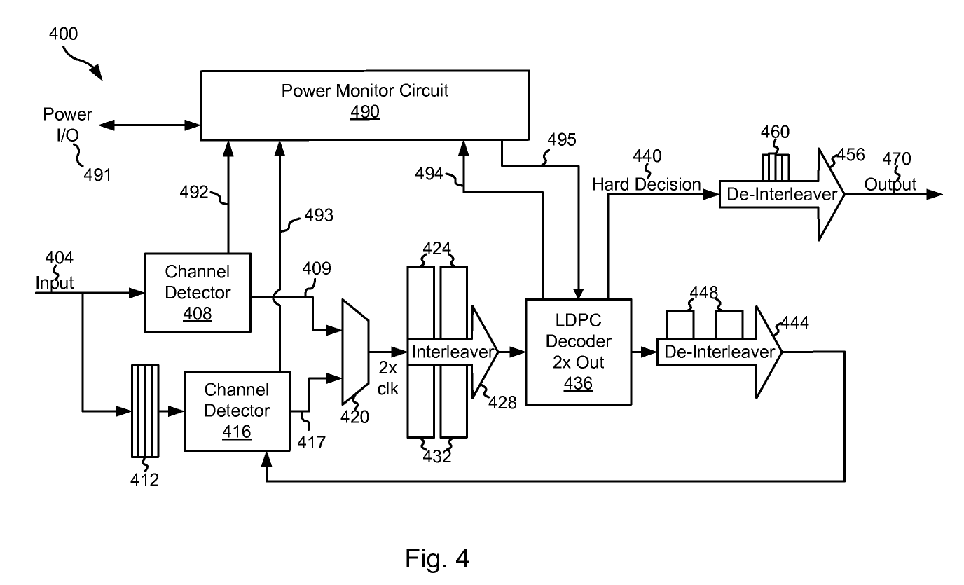

Turning to FIG. 4, a combination variable data processing and power monitor circuit 400 is shown in accordance with various embodiments of the present invention. Combination variable data processing and power monitor circuit 400 includes a data input 404 that is fed to a channel detector 408. Channel detector 408 may be any type of channel detector known in the art including, but not limited to, a soft output Viterbi algorithm detector (SOVA) or a maximum a posteriori (MAP) detector. Based on the disclosure provided herein, one of ordinary skill in the art will recognize a variety of channel detectors that may be used in accordance with different embodiments of the present invention. In addition, data input 404 is provided to a input data buffer 412 that is designed to hold a number of data sets received from data input 404. The size of input data buffer 412 may be selected to provide sufficient buffering such that a data set input via data input 404 remains available at least until a first iteration processing of that same data set is complete and the processed data is available in a ping pong buffer 448 (i.e., a queuing buffer) as more fully described below. Input data buffer 412 provides the data sets to a channel detector 416. Similar to channel detector 408, channel detector 416 may be any type of channel detector known in the art including, but not limited to, a SOVA detector or a MAP detector. Again, based on the disclosure provided herein, one of ordinary skill in the art will recognize a variety of channel detectors that may be used in accordance with different embodiments of the present invention.

An output 409 from channel detector 408 and an output 417 from channel detector 416 are provided to an interleaver circuit 428 via a multiplexer 420. Such outputs may be, for example, log likelihood ratio values. Interleaver circuit 420 interleaves the output of channel detector 408 and separately interleaves the output of channel detector 416 using two ping pong buffers 424, 432. One of the buffers in ping pong buffer 424 holds the result of a prior interleaving process of the output from channel detector 408 and is unloaded to a low density parity check (LDPC) decoder 436, while the other buffer of ping pong buffer 424 holds a data set from channel detector 408 that is currently being interleaved. Similarly, one of the buffers in ping pong buffer 432 holds the result of a prior interleaving process of the output from channel detector 416 and is unloaded to LDPC decoder 436, while the other buffer of ping pong buffer 424 holds a data set from channel detector 416 that is currently being interleaved.

In addition, channel detector 408 provides a status signal 492 to a power monitor circuit 490. When asserted as a logic ‘1’, status signal 492 indicates that channel detector 408 is busy processing a data input. Conversely, where asserted as a logic ‘0’, status signal 492 indicates that channel detector 408 is idle. An estimated power usage by channel detector 408 is programmed into power monitor circuit 490 that corresponds to the “busy” status, and another estimated power usage by channel detector 408 is programmed into power monitor circuit 490 that corresponds to the “idle” status. Similarly, channel detector 416 provides a status signal 493 to power monitor circuit 490. When asserted as a logic ‘1’, status signal 493 indicates that channel detector 416 is busy processing a data input. Conversely, where asserted as a logic ‘0’, status signal 493 indicates that channel detector 416 is idle. An estimated power usage by channel detector 416 is programmed into power monitor circuit 490 that corresponds to the “busy” status, and another estimated power usage by channel detector 416 is programmed into power monitor circuit 490 that corresponds to the “idle” status.

LDPC decoder 436 is capable of decoding one or more data sets simultaneously. As an example, LDPC decoder 436 may be designed to decode an interleaved data set from ping pong buffer 424, or an interleaved data set from ping pong buffer 432, or to decode interleaved data sets from ping pong buffer 424 and ping pong buffer 432 simultaneously. The decoded data is either provided as a hard decision output 440 and/or to a de-interleaver circuit 444 that uses ping pong buffer 448 to de-interleave the decoded data and to provide the de-interleaved data as an input to channel detector 416. One of the buffers in ping pong buffer 448 holds the result of a prior de-interleaving process and is unloaded to channel detector 416, while the other buffer of ping pong buffer 448 holds a decoded data set currently being de-interleaved. Hard decision output 440 is provided to a de-interleaver circuit 456 that de-interleaves hard decision output 440 and stores the de-interleaved result in an output data buffer 460. Ultimately, de-interleaver circuit 456 provides the de-interleaved data stored in output data buffer 460 as an output 470.

LDPC decoder 436 provides a status signal 494 to power monitor circuit 490. When asserted as a logic ‘1’, status signal 494 indicates that LDPC decoder 436 is busy processing a data input. Conversely, where asserted as a logic ‘0’, status signal 494 indicates that LDPC decoder 436 is idle. An estimated power usage by LDPC decoder 436 is programmed into power monitor circuit 490 that corresponds to the “busy” status, and another estimated power usage by LDPC decoder 436 is programmed into power monitor circuit 490 that corresponds to the “idle” status. In addition, an enable signal 495 is provided from power monitor circuit 490 to LDPC decoder 436. When asserted as a logic 1 1’, enable signal 495 allows operation of LDPC decoder 436. Conversely, when asserted as a logic ‘0’, enable signal 495 disables operation of LDPC decoder 436.

In operation, a first data set is introduced via data input 404 to channel detector 408. Channel detector 408 performs its channel detection algorithm and provides both a hard output and a soft output to multiplexer 420. The hard and soft decision data is written to one buffer of ping pong buffer 424. At the same time the detector output is written into the buffer, interleaver 428 interleaves the data set by writing consecutive data into non-consecutive memory/buffer addresses based on the interleaver algorithm/mapping. Once interleaver 424 completes its interleaving process, the interleaved data is decoded by LDPC decoder 436. Where the data converges, LDPC decoder 436 writes its output as hard decision output 440 to output data buffer 460 and the processing is completed for that particular data set. Alternatively, where the data does not converge, LDPC decoder 436 writes its output (both soft and hard) to ping pong buffer 448. As more fully described below, the scheduling guarantees that there is at least one empty buffer for holding this new set of data, and this strategy assures that each data input is guaranteed the possibility of at least two global iterations (i.e., two passes through a detector and decoder pair).

The data written to ping pong buffer 448 is fed back to channel detector 416. Channel detector 416 selects the data set that corresponds to the output in ping pong buffer 448 from input data buffer 412 and performs a subsequent data detection aided by the soft output data generated by LDPC decoder 436 fed back from ping pong buffer 448. By using the previously generated soft data for data maintained in input data buffer 412, channel detector 416 generally performs a subsequent channel detection with heightened accuracy. The output of this subsequent channel detection is passed to interleaver 428 via multiplexer 420. The data is written to one buffer of ping pong buffer 432, and interleaver 428 interleaves the data. The interleaved data is then passed to LDPC decoder 436 where it is decoded a second time. Similar to the first iteration, a decision is made as to whether the data converged or whether there is insufficient space in ping pong buffer 448 to handle the data. Where such is the case, LDPC decoder 436 writes its output as hard decision output 440 to output data buffer 460 and the processing is complete for that particular data set. Alternatively, where the data does not converge and there is sufficient buffer space in ping pong buffer 448 to receive an additional data set, writes its output (both soft and hard) to ping pong buffer 448 where it is passed back to channel detector 416 for a third pass. Sufficient space is defined in ping pong buffer 448 by having at least reserved space for the data set from the first detector and decoder after the data set from the second detector and decoder is written into the ping pong buffer.

It should be noted that, as an example, a first data set may be applied at data input 404 and that it takes a number of iterations to converge while all subsequent data sets applied at data input 404 converge on the first pass (i.e., on a single iteration). In such a case, the first data set may be processed a number of times (i.e., a number of iterations) that is limited by the amount of memory available in output data buffer 460. Once output data buffer 460 is full or once an ordered set of outputs are available, the most recent hard decision output corresponding to the first data set is provided as a hard decision output and de-interleaver 456 re-orders the outputs putting the first output in the first position. With this done, output data buffer 460 are flushed out as output 470. In some embodiments of the present invention, de-interleaver 456 does not perform a re-ordering function and output data buffer 460 has a very limited size. In such a case, it is conceivable that a data set could be processed a very large number times (i.e., a large number of iterations) only limited by how long a recipient of output 470 is willing to wait for the data. As another example, it is possible that all data applied as data input 404 converges on its first pass. In such a case, channel detector 416, LDPC decoder 436 and/or de-interleaver 444 may be placed in a power saving mode to conserve power. As yet another example, it may be the case that all data sets applied at data input 404 fail to converge on the first pass (i.e., a single iteration). In such a case, all data sets would be iterated twice. It should also be noted that one or more additional channel detectors may be added along with additional space in ping pong buffers 424, 432, 448 that would facilitate more iterations in the situation where a significant number of closely located data sets fail to converge. In such cases, all data sets can be guaranteed to be decoded with number of iterations the same as the number of detectors.

Power monitor circuit 490 calculates an estimated average power usage and/or an estimated instant power usage by combination variable data processing and power monitor circuit 400. In particular, power monitor circuit 490 combines the assertion levels of status signal 492, status signal 493 and status signal 494 with corresponding programmed estimated power usage values for each of channel detector 408, channel detector 416, and LDPC decoder 436. The calculated average power usage information is provided as a power I/O 491.

Power I/O 491 may be provided, for example, to an event monitor and control circuit (not shown). The event monitor and control circuit controls operation of combination variable data processing and power monitor circuit 400 based upon the power usage information. For example, where the power usage exceeds a defined limit, the event monitor and control circuit provides an indication via power I/O 491 to reduce power usage. The power usage is reduced by asserting enable signal 495 such that operation of LDPC decoder 436 is temporarily disabled. In time, disabling LDPC decoder 436 results in a disabling of channel detector 408 and channel detector 416, and corresponding memories and interleaver circuits. Once the power consumption issue is resolved, LDPC decoder 436 is enabled again resulting in a restart of the circuit. Power monitor circuit 490 may be implemented similar to that described above in relation to FIG. 3a where multiple power monitor circuits 300 are used, or a combination of FIG. 3a and FIG. 3b allowing for performing power monitoring of multiple power using circuits using a single power monitor circuit 300. Further, some operational approaches may be similar to those described below in relation to FIGS. 5 and 6.

It should be noted that power monitoring and/or governance in accordance with different embodiments of the present invention may be applied to a variety of different data processing circuits. For example, such power monitoring and/or power governance may be applied to data processing circuits such as those described in U.S. patent application Ser. No. 12/114,462 entitled “Systems and Methods for Queue Based Data Detection and Decoding” and filed May 2, 2008 by Yang et al. The entirety of the aforementioned reference is incorporated herein by reference for all purposes. As another example, such power monitoring and/or power governance may be applied to data processing circuits such as those described in U.S. patent application Ser. No. 12/785,416 entitled “Systems and Methods for Variable Data Processing Using a Central Queue” and filed May 21, 2010 by Gunnam et al. The entirety of the aforementioned reference is incorporated herein by reference for all purposes. Based upon the disclosure provided herein, one of ordinary skill in the art will recognize a variety of other data processing circuits that may be used in relation to different embodiments of the present invention.

Turning to FIG. 5, a flow diagram 500 shows a method in accordance with some embodiments of the present invention for power monitoring in a variable data processing system. Following flow diagram 500, a threshold is calculated based on a desired utilization and window size (block 505). This threshold may be calculated in accordance with the following equation:

Threshold=(Utilization Input)*(Window Size Input)/100,

where the utilization input is a programmable value between 0 and 100 indicating a desired level of circuit utilization, and the window size input indicates a number of bit periods over which the power status is calculated.

Where multiple distinct power using circuits are being monitored, the received status from each of the circuits may be normalized to yield a composite utilization (block 510). This may include, for example, summing scaled versions of the power status inputs received from each of the respective circuits. Based upon the disclosure provided herein, one of ordinary skill in the art will recognize a variety of approaches that may be used to normalize received inputs and provided as a composite input. Where multiple inputs are received and a composite input is calculated (block 510), the composite input is measured to yield a utilization value indicating the amount of utilization over a short period (block 515). Alternatively, where only a single power status signal is received, the received power status signal is measured to yield a utilization value indicating the amount of utilization over a short period (block 515).

It is determined whether a first mode or a second mode is selected (block 520). Where the first mode is selected (block 520), a feedback based power calculation is performed based upon the utilization value to yield a power status output (block 525). In some cases, the feedback based power calculation is performed in accordance with the following equation:

Overall power status output (P[i+1]) may be calculated in accordance with the following equation:

P[i+1]=P[i]*gain A+(C−W*U/100)*gain b,

where P[i+1] is the power status output, P[i] is a prior power status output, gain A and gain B are two programmable tuning values, C is the utilization value, U is a 359, U is desired level of utilization, and W is window size input. Alternatively, where the second mode is selected (block 520), an accumulated average utilization is calculated by accumulating a number of utilization values on a first in, first out basis over a defined averaging window to yield a power status output (block 530).

It is then determined whether the calculated power status output exceeds the previously calculated threshold (block 535). Where the power status output does not exceed the calculated threshold (block 535), an excess power status flag is de-asserted (block 540) and the processes of blocks 510-545 are repeated for the next bit period. Alternatively, where the power status output exceeds the calculated threshold (block 535), an excess power status flag is asserted (block 545) and the processes of blocks 510-545 are repeated for the next bit period.

Turning to FIG. 6, a flow diagram 600 shows a method in accordance with one or more embodiments of the present invention for governing a variable data processing circuit based on power monitoring thresholds. Following flow diagram 600, it is determined whether a power status flag is asserted indicating excessive power usage (block 605). Where excess power usage is not indicated (block 605), all circuits associated with an input operational status signal are enabled (block 610).

Alternatively, where excess power usage is indicated (block 605), it is determined whether multiple circuits are to be disabled or whether a single bottleneck circuit is to be disabled (block 615). Where multiple circuits are to be disabled (block 615), the circuits associated with the one or more operational status signals are disabled (block 635). Alternatively, where only a bottleneck circuit is to be disabled (block 615), the bottleneck circuit is selected from one of a number of circuits associated with the one or more operation operational status signals (block 620). Using combination variable data processing and power monitor circuit 400 as an example, decoder circuit 436 may be selected as the bottleneck circuit. In this case, where decoder circuit 436 is disabled, the operation of both channel detector 408 and channel detector 416 stop as soon as the ping-bong output buffers associated therewith are filled, and the other buffer still holds data waiting for processing by decoder circuit 436. The selected circuit is then disabled (block 625).

It should be noted that the various blocks discussed in the above application may be implemented in integrated circuits along with other functionality. Such integrated circuits may include all of the functions of a given block, system or circuit, or only a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

In conclusion, the invention provides novel systems, devices, methods and arrangements for power monitoring. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A data processing circuit, the data processing circuit comprising:
a data detector circuit operable to apply a data detection algorithm to a data input and a decoded output to yield a detected output;
a data decoder circuit operable to apply a data decoding algorithm to the detected output to yield the decoded output; and
a power monitor circuit operable to receive a first power status signal from the data detector circuit and a second power status from the data decoder circuit, and to calculate a power usage of a combination of at least the data detector circuit and the data decoder circuit, wherein a number of global iterations through a combination of the data decoder circuit and the data detector circuit is variable and both of the first power status signal and the second power status signal varies at least in part as a function of the number of global iterations.

2. The data processing circuit of claim 1, wherein a number of local iterations through the data decoder circuit is variable and the second power status signal varies at least in part as a function of the number of local iterations.

3. The data processing circuit of claim 1, wherein the data detector circuit is selected from a group consisting of: a Viterbi algorithm detector circuit, and a maximum a posteriori algorithm detector circuit.

4. The data processing circuit of claim 1, wherein the data decoder circuit is a low density parity check decoder circuit.

5. The data processing circuit of claim 1, wherein the first power status signal indicates the data detector circuit is busy when asserted and indicates the data detector circuit is idle when de-asserted; and wherein the second power status signal indicates the data decoder circuit is busy when asserted and indicates the data decoder circuit is idle when de-asserted.

6. The data processing circuit of claim 1, wherein the circuit further comprises:
a comparator circuit operable to compare the power usage with a threshold to yield a comparison output; and
an disabling output, wherein the disabling output is operable to disable at least the data decoder circuit when the comparison output indicates that the power usage is greater than the threshold.

7. The circuit of claim 1, wherein the circuit is implemented as an integrated circuit.

8. The circuit of claim 1, wherein the circuit is incorporated in a device selected from a group consisting of: a storage device, and a data transmission device.

9. The circuit of claim 1, wherein the power monitor circuit comprises:
a first mode circuit and a second mode circuit, wherein the first mode circuit uses a feedback based approach to calculate the power usage; and wherein the second mode circuit is operable to accumulate a power status over a window of time, and to provide the accumulated power status as the power usage.

10. The circuit of claim 6, wherein the circuit includes a threshold calculation circuit operable to calculate the threshold based at least in part on a desired utilization and a window size.

11. The circuit of claim 10, wherein the desired utilization and the window size are programmable.

12. The circuit of claim 1, wherein the circuit further comprises:
a power status normalization circuit operable to normalize the first power status signal and the second power status signal to one, and to aggregate the normalized first power status signal and the normalized second power status signal to yield the power usage.

13. A data processing circuit, the data processing circuit comprising:
a data detector circuit operable to apply a data detection algorithm to a data input and a decoded output to yield a detected output;
a data decoder circuit operable to apply a data decoding algorithm to the detected output to yield the decoded output; and
a first power monitor circuit operable to receive a first power status signal from the data detector circuit and to calculate a first power usage of the data detector circuit, wherein a number of local iterations through the data detector circuit is variable and the first power status signal varies at least in part as a function of the number of local iterations through the data detector circuit;
a second power monitor circuit operable to receive a second power status signal from the data decoder circuit and to calculate a second power usage of the data decoder circuit, wherein a number of local iterations through the data decoder circuit is variable and the first power status signal varies at least in part as a function of the number of local iterations through the data detector circuit;
wherein a number of global iterations through a combination of the data decoder circuit and the data detector circuit is variable and both of the first power status signal and the second power status signal varies at least in part as a function of the number of global iterations; and
an aggregator circuit operable to combine the first power usage with the second power usage to yield a composite power usage.

14. The data processing circuit of claim 13, wherein the first power status signal indicates the data detector circuit is busy when asserted and indicates the data detector circuit is idle when de-asserted; and wherein the second power status signal indicates the data decoder circuit is busy when asserted and indicates the data decoder circuit is idle when de-asserted.

15. The data processing circuit of claim 13, wherein the circuit further comprises:
a comparator circuit operable to compare the composite power usage with a threshold to yield a comparison output; and
an disabling output, wherein the disabling output is operable to disable at least the data decoder circuit when the comparison output indicates that the power usage is greater than the threshold.

16. The circuit of claim 1, wherein the circuit includes a threshold calculation circuit operable to calculate the threshold based at least in part on a desired utilization and a window size.

17. The circuit of claim 13, wherein the circuit is implemented as an integrated circuit.

18. The circuit of claim 13, wherein the circuit is incorporated in a device selected from a group consisting of: a storage device, and a data transmission device.

19. A power monitoring circuit, the power monitoring circuit comprising:
a threshold calculation circuit operable to calculate a threshold based at least in part on a desired utilization and a window size;
a utilization circuit operable to calculate a utilization value based upon an assertion level of a first power status signal from a data detector circuit and an assertion level of a second power status signal from a data decoder circuit;
a first mode circuit operable to use a feedback based approach to calculate a power usage based at least in part on the utilization value;
a second mode circuit operable to accumulate a power status over a window of time, and to provide the accumulated power status as the power usage; and
a comparator circuit operable to compare the power usage with the threshold to yield a comparison output.

20. The circuit of claim 19, wherein the circuit is incorporated in a device selected from a group consisting of: a storage device, and a data transmission device.
